(19) United States
(12) Patent Application Publication
(10) Pub. No.: US 2015/0037654 A1
(43) Pub. Date: Feb. 5, 2015

(54) PERFORATED POLYMER FILMS HAVING IMPROVED TOLERANCE TO TENSILE STRESS

(71) Applicants: Matthias Pascaly, Frankfurt (DE); Michael Kube, Haltern am See (DE); Ulrich Boes, Frankfurt a. M. (DE)

(72) Inventors: Matthias Pascaly, Frankfurt (DE); Michael Kube, Haltern am See (DE); Ulrich Boes, Frankfurt a. M. (DE)

(73) Assignee: Evonik Litarion GmbH, Kamenz (DE)

(21) Appl. No.: 14/384,041

(22) PCT Filed: Feb. 11, 2013
(86) PCT No.: PCT/EP13/52660

§ 371 Date: Sep. 9, 2014

(30) Foreign Application Priority Data
Mar. 9, 2012 (DE) 10 2012 203 755.1

(51) Int. Cl. H01M 2/16

(52) U.S. Cl. CPC H01M 2/16
USPC 429/145; 429/249; 429/254; 429/253

(57) ABSTRACT

The invention relates to a perforated polymer film with porosity P from 30% to 50% and with an arrangement of perforations which is characterized by the perforation shape, the ratio of the semiaxes of the perforations, the orientation of the perforations, and the regular arrangement of the perforations, where the longitudinal tensile stress that the polymer film withstands without breaking is greater than that for identical porosity and any other arrangement of perforations which differs in at least one feature.

### FIELD OF THE INVENTION

The invention relates to the design and the properties of thin perforated films and in particular films with high porosity which do not break during operations such as the application of a coating or adhesive.

### BACKGROUND TO THE INVENTION

Porous films, including microperforated films, are well known, and a wide variety of uses and production processes has been discovered for these materials. Among uses that have been described are battery separator, filter, air-permeable flexible packaging, components of wound dressings, and air-permeable membranes for use in apparel. Among production processes are, for example, those assessed in “A review on the separators of liquid electrolyte Li-ion batteries”, Journal of Power Sources, 164, (2007), 351-64. Among these processes are those known as dry and wet processes, phase inversion and thermally induced liquid-liquid phase separation. The said assessment also describes how membranes, including perforated polymer films, where these are produced for use as battery separator, can then be modified in a coating process in order to modify and to improve their properties in respect of, for example, wetability or interfacial contact between the separator and the electrodes.

Other production processes include the formation of cavities in films by a wide variety of perforation processes, among which are needle-punching, electrostatic discharge, treatment with high-energy particles, point application of reduced pressure and la ser perforation.

Porous films are typically characterized by a number of parameters, including the nature of their perforations, of the perforation pattern, of the porosity, which for the purposes of the present invention is also termed “open area”, and also of the material, of the firm thickness, of the tensile strength and of the modulus of elasticity.

A wide variety of publications describe thin, microperforated polymer films. As an example, JP A 2006-6326860 describes microperforated polymer films with thicknesses in the range from 1 to 25 μm and with an open area of more than 10%. JP A 06100720 describes porous polypropylene films with tensile strength in the range from 60-150 N/mm².

JP A 10-330521 describes high-tensile-strength polyolefin films with thickness in the range from 10 to 120 μm, produced by needle perforation or laser perforation and having a tensile strength, based on the thickness, of up to 10 kg/5 cm=20 N/cm.

DE C 196 47 543 describes a thin perforated film web as packaging material similar to a stretch film, the perforations of which open on application of a tensile stress, but without giving any more detail of the tensile stress.

Although thin, porous polymer films have been described in the prior art, and various minimum values (e.g. tensile strength, thickness, porosity, perforation diameter) have been specified or can be calculated, it appears that no account has been taken of the requirements relating to the need for, or processing of, stable thin porous films. In particular, there is no information concerning the stability required in order then to withstand a coating process, or concerning the resultant requirement for a minimum tensile strength. Films with thicknesses in the μm range which comply with these requirements have also been provided.

The object of the present invention therefore consists in providing porous polymer films of uniform thickness which withstand a maximum tensile stress, and which can therefore be processed in the roll-to-roll processes conventional in the prior art, without breaking.

### SUMMARY OF THE INVENTION

The invention provides a perforated polymer film with porosity P, 50%≧P≧30%, and with an arrangement of perforations A0, which is characterized by

A01 perforation shape,

A02 ratio of the semiaxes of the perforations

A03 orientation of the perforations, and

A04 regular arrangement of the perforations,

where the longitudinal tensile stress that the polymer film withstands without breaking is greater than that for identical porosity and any other arrangement of perforations which differs from A0 in at least one feature of A01, A02, A03, and/or A04.

The meaning here and hereinafter of the term porosity is the quotient calculated from the area occupied by the perforations, abbreviated to area_{perforation}, divided by the area occupied by the unperforated film, where this means the film prior to perforation, abbreviated to area_{film}, in per cent,

porosity=(area_{perforation}/area_{film})*100%.

For the purposes of the invention, the tensile stress is the maximum force per unit of cross-sectional area of the polymer film that does not break the film, calculated in accordance with ASTM D882-10 in the tensile test, based on the original cross section of the film. A factor that has to be taken into account here, of course, is that the film becomes narrower perpendicularly to the direction of tension. The tensile stress is stated in MPa and is always exerted in the web direction along which the polymer film is unwound and wound up.

For the purposes of the invention, the perforation shape means the geometric shape of the perforations. In particular, the perforation shape can be an ellipse, a circle, or an irregular shape.

For the purposes of the invention, orientation of the perforations means the orientation of the largest semiaxes of the perforations relative to the direction of tension. The direction of tension of the polymer film according to the invention is the same as the direction in which the tensile forces act on the film in a roll-to-roll process. It is particularly preferable that the orientation of the perforations is parallel to the direction of tension.

The regular arrangement of the perforations in the film according to the invention is such as to give a simplest-possible arrangement of perforations which tessellates the film. In particular, this type of arrangement of the perforations can be rectangular, hexagonal, or rhomboidal.

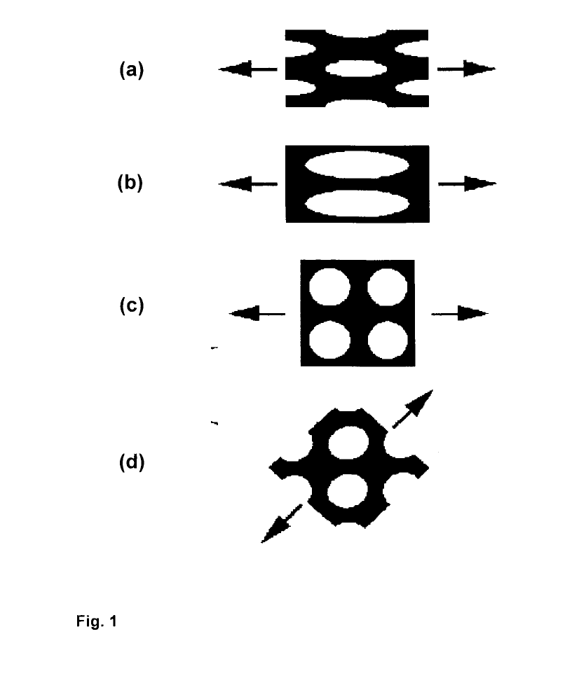

FIGS. 1(a) to (d) are diagrams of various arrangements of the perforations, and the arrows in these figures show the direction of tension.

The invention also provides the use of the polymer film according to the invention as packaging material for protection from gases, as electrochemical membrane, membrane for air-conditioning systems, apparel, cleaning rooms, filtration, or separation or as battery separator.

The invention further provides a laminate comprising the polymer film according to the invention a porous medium onto which the polymer film has been laminated.

The invention also provides a battery with a battery separator which comprises the polymer film according to the invention or the laminate according to the invention.

Separation means any division or isolation of media. In particular, the polymer film according to the invention can be used to separate constituents in food or drink, in fermentation products, e.g. beer, or in liquid nutrition, preferably dairy products.

### DETAILED DESCRIPTION OF THE INVENTION

The tensile stress can be measured with what is known as transverse strain inhibition. When transverse strain inhibition is used, machinery inhibits width-reduction of the film while it is exposed to tensile load. The usual method here uses width-extension rolls, brush rolls, convex rolls or curved deflector tubes. A second tensile force is thus produced perpendicularly with respect to the direction of winding, and this increases the tensile stress that can be exerted without breaking.

It is preferable that the perforated polymer film according to the invention withstands a tensile stress Z, where Z is in the range from

Z=(90.6−142·P) MPa to Z=(80.9−95·P) MPa.

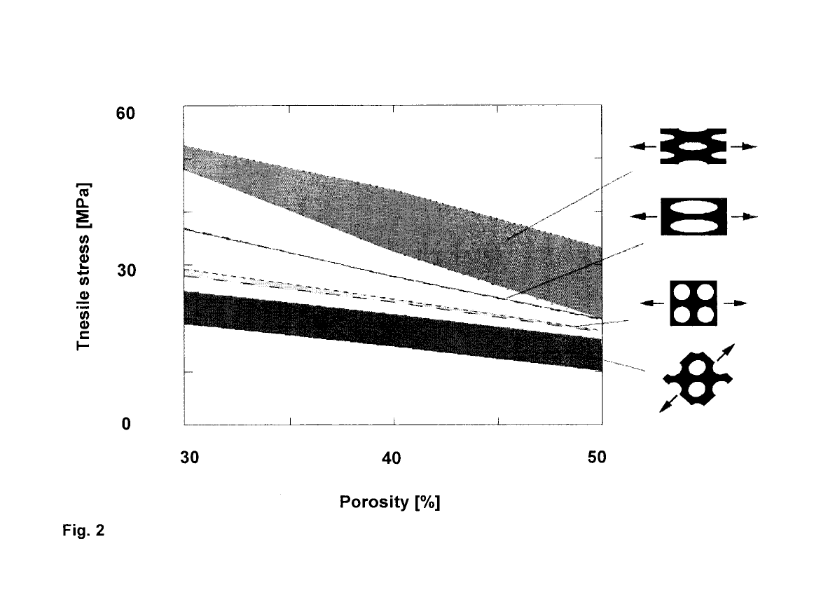

The said range is shown in FIG. 2, where the arrangement of the perforations corresponds to FIG. 1(a). On exposure to the tensile stress Z, the polymer film exhibits tensile strain, without breaking.

The perforation shape of the polymer film according to the invention can be smooth and convex, selected from oval without or with at least one axis of symmetry, or can be a shape which has edges, without or with at least one axis of symmetry. Perforations with smooth and convex shape can be those selected from oval, without or with at least one axis of symmetry, or can be a shape with edges without or with at least one axis of symmetry.

In an embodiment which can be particularly advantageous, the polymer film according to the invention has elliptical perforations with an axis ratio of from 1.5:1 to 5:1, more preferably from 2:1 to 4:1, particularly preferably from 2.8:1 to 3.2:1, and very particularly preferably 3:1. It is preferable that the axis ratio varies by at most 10%.

The arrangement of the perforations of the polymer film according to the invention can be at least in parallel or non-parallel rows, or can be non-straight, rhombic, rectangular, square, or hexagonal. The polymer film withstands the greatest tensile stress when the longer semiaxis lies in the direction of tension, and when the perforation arrangement is an offset rectangular grid, also termed “offset ellipses” for the purposes of the invention. The situation is shown diagrammatically in FIG. 1(a).

The material of the polymer film according to the invention can be one selected from polyethylene (PE), polypropylene (PP), polyethylene glycol terephthalate (PET), polyethylene glycol naphthenate (PEN), polylactic acid (PLA), polyacrylonitrile (PAN), polyamides (PA), aromatic polyamides (Ar), polymethyl methacrylate (PMMA), polyimide (PI), polyester copolymers, polyolefins, fluorinated polymers, polystyrene, polycarbonate, acrylonitrile-butadiene-styrene, cellulose ester, copolymers of the said polymers, and mixtures of the said polymers and/or copolymers. Preferred materials are PET, PEN, and particularly PET. Particular preference is given to polyacrylonitrile and polystyrene. Among the fluorinated polymers, particular preference is given to polyvinylidene fluoride.

The thickness d of the film is preferably at most 20 μm, particularly preferably at most 5 μm. A preferred lower limit for the thickness of film according to the present invention is about 1 μm.

There can be a ceramic coating applied to the polymer film according to the invention. The polymer film can also have been impregnated with a ceramic or non-ceramic material.

Further embodiments of the present invention include a process for producing a perforated film of the type described above, a coated perforated film, various uses of the optionally coated or impregnated perforated film, including uses as battery separator, as air-permeable packaging material, as electrochemical membrane and as disposable filter medium, and laminates of the optionally coated perforated film.

The weight of the film according to the invention can be from 40 to 100% of the weight of the equivalent non-perforated film.

The film according to the invention can moreover comprise additional components, e.g. plasticizers, mineral particles, waxes, dyes, lubricants, release agents or anti-adhesion agents and any desired other additives known from the prior art. Additives of this type are capable of modifying the functionality or the appearance of the film, and this affects properties such as stiffness, tensile strength, blocking, slip, gloss, opacity, surface roughness, surface conductivity and volume conductivity and colour.

In one specific embodiment, the parent film, i.e. the film prior to perforation, can comprise a pigment or a dye which respectively absorbs laser energy at a suitable wavelength, in order to permit or to improve perforation by means of a laser or by means of any other type of radiation.

For the preferred laser-perforation process using a semiconductor laser arrangement, the added pigment or the added dye increases the absorption of light at the operating wavelength of the laser. Semiconductor lasers typically operate in the near infrared region of the electromagnetic spectrum in the range from 690 to 1500 nm. For certain product applications it is important to select materials which have minimum effect on the opacity or colour of the film.

The parent film can also comprise a coating or ink. The coating or the ink can be present on only one of, or on both of, the film surfaces. The coating or ink can cover the entire, or any portion of, the film surfaces. In one specific embodiment, the coating or ink has the property of absorption of energy emitted by the laser used for the perforation process, and printing of a pattern on the film surface therefore results in perforation only in the printed regions. The pattern can comprise a block area which is perforated with a plurality of perforations. As an alternative, the pattern can comprise a set of points which respectively define the position and size of an individual perforation. The coating or ink can include additives of the type described above as additive components for the polymer film, and other components, e.g. resins, surfactants, viscosity modifiers, flow aids, adhesion promoters, biocides and other coating components known from the prior art.

In one embodiment, in which the coating comprises a dye or a pigment, in order to absorb energy in the near infrared, carbon is a preferred pigment for some applications because it is easy to incorporate, is inexpensive and absorbs broadly across the entire spectral range. However, some applications require use of alternative materials in order to minimize the effect of the coating on the colour and opacity of the film material, and also to minimize effects during subsequent applications of the film.

The coating can be applied from an organic solvent or from a water-based carrier. As an alternative, it can be applied in the form of coating using 100% of solids, which is then cured by irradiation using UV light or using an electron beam source. The coating can be applied by using any desired known printing or coating process, including slot-die coating, gravure coating, roller coating and curtain coating processes. Preferred printing processes include offset, stamping, screen printing, and flexographic, gravure and rotary film printing processes, but can also include other processes, e.g. intaglio or letterpress processes and non-mechanical processes, e.g. ink-jet printing.

The thin, perforated films of the present invention and laminates thereof can be used in various end uses, irrespective of whether the said films or the said laminates are coated or uncoated, and impregnated or non-impregnated. The films of the present invention (either themselves or in laminated form) can be impregnated or coated with a wide variety of coating materials for a wide variety of purposes.

If the laminate according to the invention has been impregnated or coated with a ceramic material, i.e. after it has been perforated, the said laminate can specifically be used as battery separator which has the advantageous properties of this media type, described in the prior art.

In a specific embodiment in which the film, coated or uncoated, is laminated to a porous substrate it is possible to incorporate what is known as a “switch-off layer”. This is a safety feature which prevents uncontrolled temperature increases resulting from overloading, from physical damage or from internal effects. In a two-ply structure, for example a laminate formed from a perforated film and from a non-woven, it is possible to produce a switch-off layer by selecting the same components in such a way that one component provides mechanical strength and heat resistance and the other component provides the switch-off function by virtue of its relatively low melting point. In the event of a potentially catastrophic short-circuit which causes the temperature to rise within the battery, the switch-off layer melts in such a way that the pores in the other component become blocked, in essence thus stopping the ion flow within the battery cell and thereby preventing a thermal loss of control. The melting point of the switch-off layer is typically 130° C. or less, as described in the prior art. The switch-off function in the present invention can by way of example be achieved through selection of a polyethylene film as component of the microperforated film in conjunction with, for example, a synthetic non-woven using polyester fibres (PET fibres) or polyester microfibres. As an alternative, the switch-off function can be provided by using a non-woven using fibres with low melting point, e.g. polyethylene fibres, combined in a laminate with a microperforated film with relatively high melting point, e.g. PET or PEN.

The high perforation level that can be achieved by the present invention makes the films useful for a number of other end uses, for example as air-permeable packaging material, electrochemical membranes for use in a wide variety of applications, and disposable filter media.

The example below provides further explanation of the present invention.

### EXAMPLE 1

### Perforated PET Film

The tensile stress that perforated polyethylene terephthalate (PET) films according to the invention, with various porosities in the range from 30 to 50%, in each case with thickness 4.5 μm, withstood without breaking was determined.

FIG. 2 shows diagrammatically the resultant tensile stress values that the respective perforated film withstood for various arrangements of the perforations and for various perforation shapes.

The film according to the invention could be exposed to the highest tensile stresses when the perforation shape was elliptical, in the offset ellipses arrangement, and when both semiaxes were larger than the thickness of the polymer film, with a ratio of 3:1. This polymer film withstood a tensile stress Z where Z is in the range from

Z=(90.6−142·P) MPa to Z=(80.9−95·P) MPa.

The said range is shown in FIG. 2, where the arrangement of the perforations corresponds to FIG. 1(a). On exposure to the tensile stress Z, the polymer film exhibited tensile strain, without breaking.

1. A perforated polymer film with porosity P, wherein
50%≧P≧30%,
and comprising an arrangement of perforations A0, characterized by
A01 perforation shape,
A02 ratio of the semiaxes of the perforations,
A03 orientation of the perforations, and
A04 regular arrangement of the perforations,
where the longitudinal tensile stress that the polymer film withstands without breaking is greater than that for identical porosity and any other arrangement of perforations which differs from A0 in at least one feature of A01, A02, A03, and/or A04.

2. The perforated polymer film according to claim 1 which withstands a tensile stress Z, where
Z is from
Z=(90.6−142·P) MPa to Z=(80.9−95·P) MPa.

3. The perforated polymer film according to claim 1, wherein
the perforations are offset ellipses, and where the ratio of axes is from 1.5:1 to 5:1, and
the longer semiaxis lies in the direction of tension.

4. The perforated polymer film according to claim 1, wherein
the material of the polymer film is one selected from polyethylene (PE), polypropylene (PP), polyethylene glycol terephthalate (PET), polyethylene glycol naphthenate (PEN), polylactic acid (PLA), polyacrylonitrile (PAN), polyamides (PA), aromatic polyamides (Ar), polymethyl methacrylate (PMMA), polyimide (PI), polyester copolymers, polyolefins, fluorinated polymers, polystyrene, polycarbonate, acrylonitrile-butadiene-styrene, cellulose ester, copolymers of the said polymers, and mixtures of the said polymers and/or copolymers.

5. The perforated polymer film according to claim 1, wherein a ceramic coating has been applied.

6. A packaging material for protection from gases, an electrochemical membrane, a membrane for air-conditioning systems, apparel, cleaning rooms, filtration, or separation or a battery separator comprising the perforated polymer film of claim 1.

7. A laminate comprising the polymer film according to claim 1, and a porous medium onto which the polymer film has been laminated.

8. A battery comprising a battery separator,
said separator comprises the polymer film according to claim 1.

9. The perforated polymer film according to claim 1, wherein A01 is an ellipse, a circle or an irregular shape.

10. The perforated polymer film according to claim 1, wherein A03 is parallel to the direction of tension.

11. The perforated polymer film according to claim 1, wherein A04 is rectangular, hexagonal or rhomboidal.

12. The perforated polymer film according to claim 1, wherein said film is impregnated with a ceramic or non-ceramic material.

13. A battery comprising a battery separator, said separator comprises the laminate from claim 7.

14. The perforated polymer film according to claim 1, wherein said film has a thickness of from 1 μm to 20 μm.

15. The perforated polymer film according to claim 1, further comprising plasticizers, mineral particles, waxes, dyes, lubricants, release agents and/or anti-adhesion agents.

16. The laminate according to claim 7, wherein said laminate further comprises a switch-off layer.
